(19) United States
(12) Patent Application Publication
(10) Pub. No.: US 2013/0286787 A1
(43) Pub. Date: Oct. 31, 2013

(54) Low-Frequency Seismic-While-Drilling Source

(71) Applicant: Tempress Technologies, Inc., Kent, WA (US)

(72) Inventor: Jack J. Kolle, Seattle, WA (US)

(73) Assignee: Tempress Technologies, Inc., Kent, WA (US)

(21) Appl. No.: 13/870,866

(22) Filed: Apr. 25, 2013

Related U.S. Application Data
(60) Provisional application No. 61/638,456, filed on Apr. 25, 2012.

(51) Int. Cl. G01V 1/133

(52) U.S. Cl. CPC G01V 1/133
USPC 367/143

(57) ABSTRACT

A bottom hole assembly is configured with a drill bit section connected to a pulse generation section. The pulse generation section includes a relatively long external housing, the particular housing length being selected for the particular drilling location. The long external housing is positioned closely adjacent to the borehole sidewalls to thereby create a high speed flow course between the external walls of the housing and the borehole sidewalls. The long external housing includes a valve cartridge assembly and optionally a shock sub decoupler. While in operation, the valve cartridge assembly continuously cycles and uses downhole pressure to thereby generate seismic signal pulses that propagate to geophones or other similar sensors on the surface. The amount of bypass allowed through the valve assembly is selectable in combination with the long external housing length and width to achieve the desired pulse characteristics. The bottom hole assembly optionally includes an acoustic baffle to attenuate wave propagation going up the drill string.

### RELATED APPLICATIONS

The present application claims the benefit of U.S. Provisional Patent Application, Ser. No. 61/638,456 filed on Apr. 25, 2012 and U.S. Non-Provisional patent application Ser. No. 12/957,049 filed on Nov. 30, 2010, each incorporated herein by reference in its entirety.

### BACKGROUND

1. Field of the Invention

The present invention relates to seismic pulse generation and downhole drilling operations.

2. Description of the Related Art

Downhole drilling tool assemblies including mud pulsers that transmit data to surface sensors on the drillstring have seen use in drilling operations for some time. In downhole drilling and especially in lateral drilling it is useful to track the position of the drilling assembly. Over time drilling operations have seen drilling to greater depths through a larger variety of geological formations. These factors and others continue to create the need for more advanced seismic source tools, seismic detectors having greater accuracy, and more sophisticated tracking means and seismic information processing algorithms. At least one benefit of including seismic sources in downhole drilling assemblies is the ability to drill while collecting seismic data which allows real-time seismic data collection and processing that in turn allows for real-time decision making based on current seismic information.

Seismic while drilling operations have been based on the noise and vibration generated by the drill bit during the drilling process, utilizing this noise and vibration as the seismic source. A number of sensors, such as geophones, are deployed at a number of locations on the surface and listen to or receive the noise and vibration generated by the downhole drill bit as the noise and vibration propagates to the surface. Drill bit sources are not effective in soft formations and PDC bits commonly used for drilling are not effective at all. It would be desirable to use a near-drill-bit source that can reliably produce seismic signals regardless of bit selection or formation type. A near bit seismic source with limited pulse duration of a few milliseconds cycle rate of 10 to 20 Hz and limited seismic energy coupling has been demonstrated. It would be desirable to generate increased pulse duration with decreased impulse cycle rate as those characteristics would allow for higher accuracy seismic interpretation. These characteristics would additionally allow for greater accuracy through a wider variety of geological formations and substrates. In addition, it would be desirable for a seismic system to have a long useful life in the harsh conditions associated with increasingly deeper drilling operations that include high temperature and high pressure environments.

### SUMMARY OF THE INVENTION

In accordance with the invention, seismic waves can be generated with increased pulse duration and decreased impulse cycle rate while minimizing source noise. These characteristics result in a less attenuated and noise-reduced seismic signal as received at the surface that can be processed to provide greater accuracy seismic data regarding downhole formations and drilling tool assembly locations. In addition, the pulse duration can be precisely tuned to provide the ideal pulse signal for a particular drilling operation. A downhole drilling tool assembly or bottom hole assembly having a drill bit section, a pulse generation section, and an acoustic baffling section, in accordance with the invention, can be configured to achieve these characteristics.

In one embodiment of the invention, a bottom hole assembly is configured with a drill bit section connected to a pulse generation section. The pulse generation section includes a relatively long external housing with enlarged diameter relative to the drillstring with each side of the housing closely adjacent to the borehole sidewalls, the particular housing diameter and length being selected for the particular drilling location. The long external housing contains a valve cartridge assembly, and may contain a shock decoupler While in operation, the valve cartridge assembly continuously cycles and modulates flow though the tool to thereby generate seismic signal pulses that propagate to geophones or other similar sensors on the surface. The cycle rate characteristics are determined by sizing flow restrictions within the pulse valve disclosed in U.S. patent application Ser. No. 12/957,049 and by varying the length of the pilot and piston components described in these same patents. In particular the cycle rate can be reduced to below 2 Hz. In one embodiment of the invention, the pulse generation section can further connect to an acoustic baffling section that serves to reflect a portion of the wave energy created by the pulse generation section. The particular acoustic baffling setup and the external housing length and diameter work together to achieve the desired pulse characteristics in terms of pulse duration, and source noise behavior. The tuning of these structures further allows for a pulse duration of between 1 and 100 ms. The length of the long external housing being selected so that the travel time of an acoustic wave in the annulus fluid approximates the pulse duration. If the drilling fluid is water, the speed of an acoustic wave is approximately 1500 m/s. For example a pulse with a duration of 10 milliseconds would have a length of 15 m so length of the housing should be 15 m.

### BRIEF DESCRIPTION OF THE DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1A is a side elevational view of an exemplary bottom hole assembly in accordance with the invention.

FIG. 1B is a side cross-sectional view of an alternative bottom hole assembly incorporating a shock sub, with arrows showing the flow of fluid through an open valve assembly.

FIG. 1C is a side cross-sectional view of the exemplary bottom hole assembly of FIG. 1B, with arrows showing the pressure pulse on the formation and the axial force pulse at the bit when the valve assembly closes.

FIG. 2A is a side elevational view of the exemplary bottom hole assembly of FIG. 2.

FIG. 2B is a side elevational view of an alternate bottom hole assembly of FIG. 2 with multiple stabilizers serving as acoustic baffles.

FIG. 2C is a side elevational view of an alternate bottom hole assembly of FIG. 2 with elongated sections of alternating collar diameter forming an acoustic baffle.

FIG. 2D is a side elevational view of an alternate bottom hole assembly of FIG. 2 with multiple sections of alternating collar diameter forming an acoustic baffle.

FIG. 3A is a side elevational view illustrating the phase shift that occurs due to the motion of a downhole seismic source.

FIG. 3B is a side elevational view illustrating a shear wave generation by a source incorporating a shock sub and the interaction of these shear waves with natural fractures.

FIG. 4 is a side elevational view illustrating reverse vertical seismic profiling with the low frequency seismic while drilling system having surface data acquisition equipment.

FIG. 5 is a side cross-sectional view of an embodiment of the valve cartridge components of the bottom hole assembly showing the poppet seat flow passage that can be selected to specify the cycle rate of a seismic source of the bottom hole assembly.

FIG. 6 is a side cross-sectional view of the internal components of another embodiment of the valve cartridge.

### DETAILED DESCRIPTION

Exemplary embodiments are illustrated in referenced Figures of the drawings. It is intended that the embodiments and Figures disclosed herein are to be considered illustrative rather than restrictive. No limitation on the scope of the technology that follows is to be imputed to the examples shown in the drawings and discussed herein.

Those skilled in the art will recognize that the seismic energy radiated by a source is determined by the square of the rate at which the force is applied, as well as the source dimensions and other factors. A source with a rapid rise time is thus critical for generating a signal with high energy that will be transmitted to surface receivers. The seismic source described in U.S. Pat. No. 7,139,219 and the hydraulic pulse valve assembly described in U.S. patent application Ser. No. 12/957,049 both generate pressure in the borehole annulus and axial force pulses with a rise time on the order of one millisecond and are therefore capable of generating strong seismic signals. U.S. Pat. No. 7,139,219 describes a source that operates at relatively high cycle rate and therefore has a bandwidth minimum of around 20 Hz. A bandwidth minimum of under 2 Hz would be desirable for seismic profiling and look-ahead seismic imaging. The pulse profile of the invention can further be optimized to match the high-speed flow course dimensions of the flow course described in U.S. Pat. No. 7,139,219 to generate a high-strength seismic signal.

In accordance with the invention, seismic waves can be generated with increased pulse duration and decreased impulse cycle rate relative to the source described in U.S. Pat. No. 7,139,219, while reducing source noise. As the generated seismic waves propagate to the surface, these initial characteristics at the source result in a less attenuated and generally lower noise seismic signal at the surface. When at the surface, the seismic waves are received by geophones or other seismic wave sensing instruments and processed. Those skilled in the art will recognize that the low frequency bandwidth of seismic energy radiated by a periodic source is limited by the cycle rate, while the energy radiated is determined by the rise time of the pulse, faster rise times generating more energy radiated as seismic energy. In addition, the bottom hole assembly allows for the pulse duration to be precisely tuned to provide the ideal pulse signal for a particular drilling operation in the sub 2 Hz range. The downhole drilling tool assembly or bottom hole assembly has a drill bit section, a pulse generation section, and an optional acoustic baffling section, in accordance with the invention and can be configured to achieve the above mentioned seismic wave characteristics.

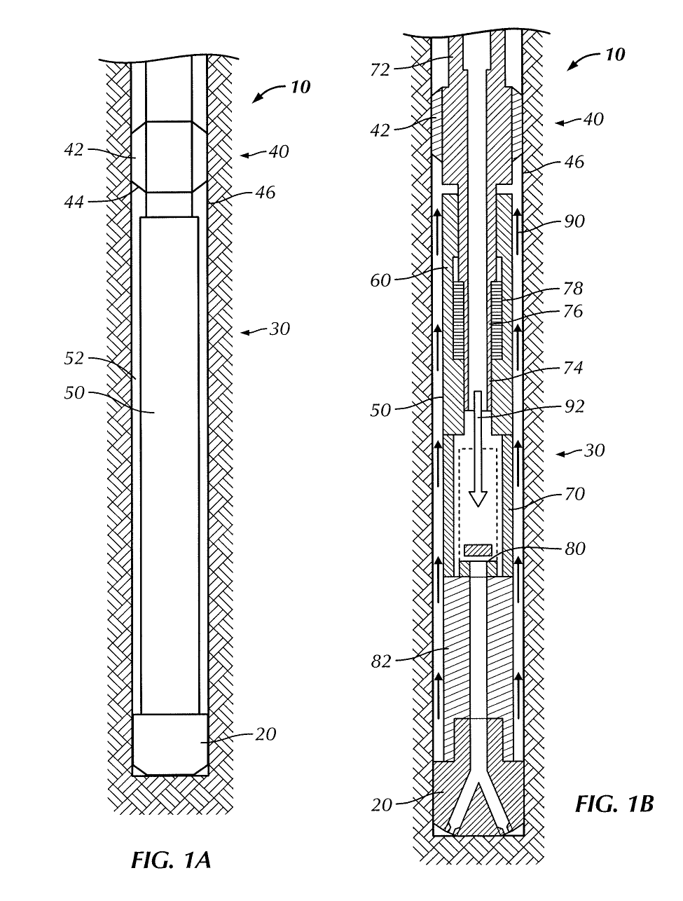

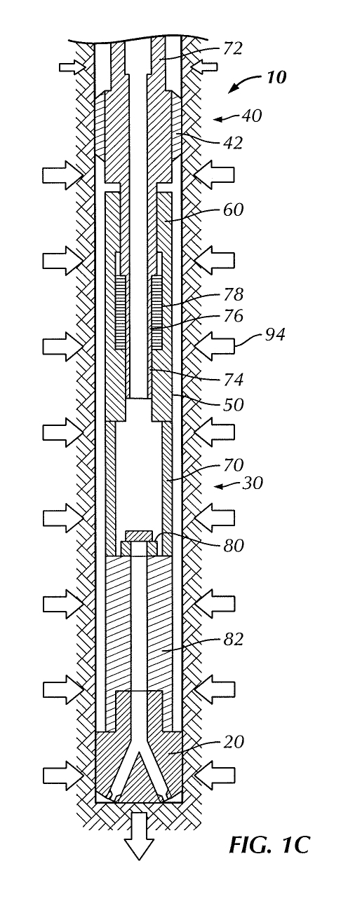

An embodiment of the low frequency seismic source while drilling bottom hole assembly 10 is shown in FIG. 1A and configured with a drill bit section 20 connected to a pulse generation section 30. In some embodiments an optional acoustic baffle section 40 is shown. In an embodiment, the acoustic baffle section 40 can include a stabilizer 42 configured with vanes 44 extending from the stabilizer 42 to the borehole walls 46. The vanes 44 cause a change in the section area of the volume between the drill string and the borehole and therefore reflect seismic energy in proportion to the change in section area. A stabilizer will therefore reflect a certain portion of the pressure wave that propagates up the annulus. Pressure waves traveling up the annulus between the drillstring and the borehole are known as tube waves and these represent a source of secondary seismic energy radiation that interferes with the primary signal generated by the pulse generation section 30. The pulse generation section 30 includes a one to twenty meter long external housing 50, the particular housing length being selected to match the distance that a pulse travels during the pulse duration. For example a pulse with a duration of 10 milliseconds has a length of approximately 15 meters in water so the housing length would be selected to be 15 m for this pulse. The housing has a large diameter relative to the drillstring diameter. The area between the housing 50 and the borehole sidewalls 46 serves as a high speed flow course 52 for pressure pulses generated by the pulse generation section 30.

In an embodiment, and as shown in FIGS. 1B and 1C, the long external housing 50 contains a shock sub decoupler 60 and a valve cartridge assembly 70. This type of shock sub is known to those skilled in the art and is shown schematically. The shock sub 60 allows for a small amount of axial movement of the bottom hole assembly below the sub relative to the drill collars 72. Shock subs can be used to dampen drilling vibrations. The torsional load of drilling is transmitted though the shock sub 60 with a spline 74 coupling that is free to slide up and down within limits. A sliding seal 76 maintains the pressure of drilling mud in the tool. Drilling weight acts against the springs 78 causing them to compress while internal pressure acts to extend the sub 60. Pressure pulses produced by the valve cartridge assembly 70 will act to extend the sub 60, thereby absorbing upstream pressure pulses and converting the pulse energy to a downward force on the drill bit 20. This downward force acts as a monopole seismic source that primarily generates shear wave energy.

As shown in FIGS. 1B and 1C, the pulse generation section 30 includes the shock sub 60, valve cartridge assembly 70 and optional drill motor 82 and is cased in a uniform diameter long external housing 50 that is relatively large compared to the drill collars. Drilling mud or water is pumped down from surface through the drillstring and through the valve cartridge assembly as shown by arrow 92. The mud exits the bit 20 and flows up though the annulus between the housing and the borehole as indicated by 90. In this example, the housing 50 diameter is 7.25 inches and the hole diameter is 8.5 inches. In a typical example, 400 gpm (1540 in³/s) of drilling mud flows upward though this annulus, as shown by arrows 90, which has a flow area of 15.5 in² at a velocity of 100 in/s. Assuming a mud weight of 10 ppg, a suction pulse of 640 psi will be generated every time the valve cartridge assembly 70 closes, the suction pulse, shown by arrows 94 in FIG. 1C. The pulse is caused by the well-known water hammer effect and the pulse amplitude in consistent metric units is equal to the product of; (1) the velocity of the mud; (2) the mud density and (3) the speed of sound in the mud. The pulse duration will be comparable to the travel time of sound in the mud up the length of the housing 50. For a 30 ft. long housing, the pulse duration will be approximately 12 milliseconds. The pulse duration generated by the valve cartridge should therefore be matched to the travel time of the pulse. By varying the size of the housing 50 and the amount of bypass though the valve 80 of the valve cartridge assembly 70, the amplitude of this pulse can be controlled. In an embodiment, the pulse generation section 30 can further connect to an acoustic baffling section 40 that serves to reflect a portion of the wave energy created by the pulse generation section 30. The particular acoustic baffling setup, the long external housing length and width, the cycle rate characteristics of the valve, and the bypass allowed through the valve assembly 70, all work together to achieve the desired pulse characteristics in terms of pulse duration and source noise behavior. Pressure pulses traveling up the annulus between the borehole and the drill collars as tube waves will radiate seismic energy that interferes with interpretation. One or more stabilizers can be located above the bottom hole assembly 10 in the acoustic baffle section 40 and will attenuate tube waves by reflecting a portion of the wave energy, thereby serving as acoustic baffles for the waves. A number of different configurations are possible for the acoustic baffle section 40, some of which are described below.

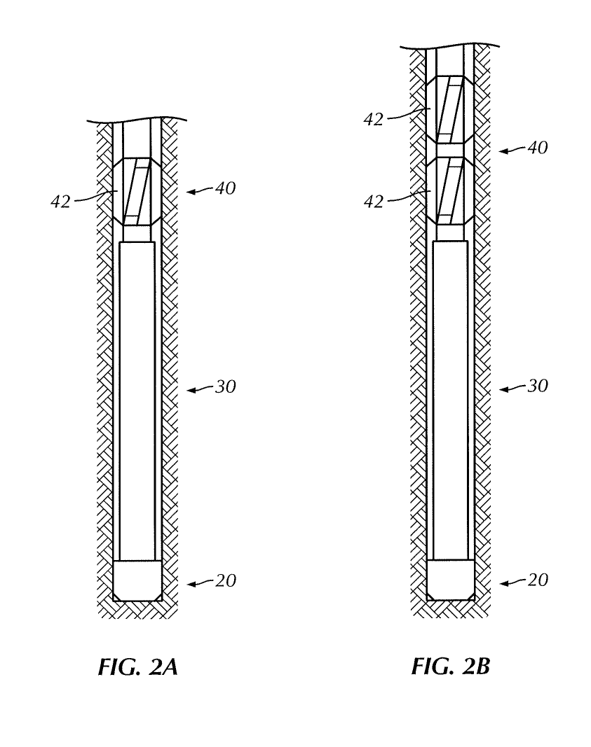

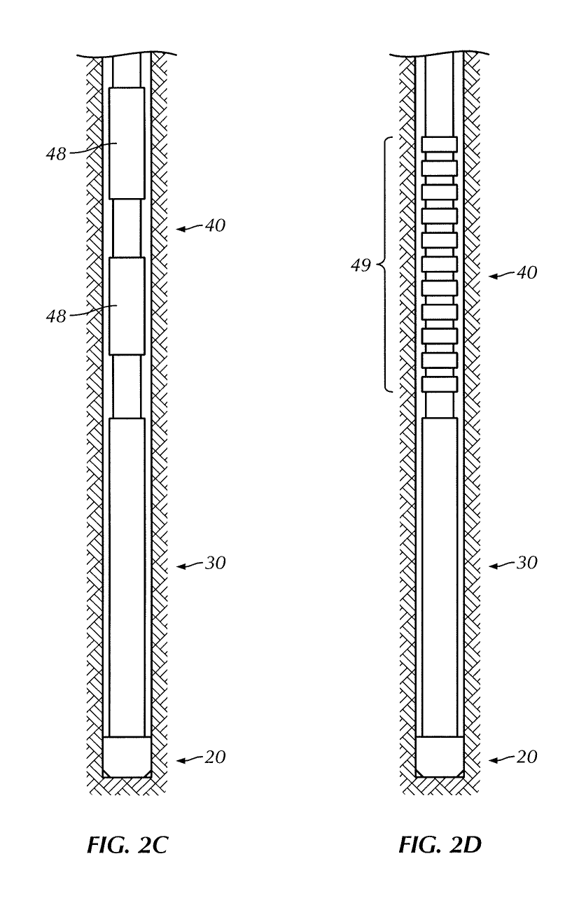

FIGS. 2A-2D show various alternate embodiments for the acoustic baffle section 40, in accordance with the invention. FIG. 2A shows an embodiment of the acoustic baffle section having one stabilizer 42. FIG. 2B shows an embodiment of the acoustic baffle section having two stabilizers 42. FIG. 2C shows an embodiment of the acoustic baffle section having two elongated sections of different collar diameters 48 that can serve as acoustic baffles. FIG. 2D shows an embodiment of the acoustic baffle section having a series of sections of varying collar diameter 49 that form a baffle. Other acoustic baffle configurations are also possible. Moreover, changes in section diameter can be effective for tube wave attenuation.

A near-bit seismic source that generates a seismic signal at the bit with a self-piloted valve cartridge assembly can be advantageous for use in a variety of seismic while drilling applications. It has been demonstrated that a surface seismic array and pilot receivers on the drill string can detect the signal resulting from the use of this tool, to enable reverse vertical-seismic-processing (rVSP). This tool, which is high pressure, high temperature (HPHT) compatible, offers the possibility of real-time seismic while drilling in any wellbore inclination.

For seismic applications it is useful to increase the interval between pulses to at least 0.5 s (e.g. 2 Hz cycle rate). The interval between pulses should be on the order of or comparable to the travel time of the pulses from the source to the surface. In 2500 m deep well the travel time of pulses to the surface is on the order of 1 second so the interval between pulses should be at least 0.5 s to avoid ambiguity in seismic interpretation. The information from multiple pulses can be added using a process called stacking, in order to increase the signal to a level that can be pulsed. So it is important to generate enough pulses for useful processing. The optimal cycle rate is in the range of 0.5 to 2 Hz. The interval between pulses can be increased by increasing the valve stroke and by modifying port sizes to reduce the differential pressure though the tool.

The pulse width can be controlled to match the travel time of pulses in the high speed flow course. This width can be reduced to under 5 ms. The combination of controlled pulse width in the range of 5 to 30 ms and cycle rate of under 2 Hz results in a relatively broadband signal. The bottom hole assembly may also be configured to optimize the annulus pressure pulse. Interruption of the high-speed fluid flow in the annulus between the bottom hole assembly and borehole generates a suction pressure pulse in the restricted flow region, as illustrated in FIGS. 1B and 1C. The bottom hole assembly can have a slick outer diameter, but can preferably have a larger diameter than the drill collars, to maximize the suction pulse amplitude. For example, a 7.25-inch diameter bottom hole assembly with a length of 15 m can provide a relatively large borehole surface area to couple the pressure pulse produced by the tool into a seismic signal. Maximizing the seismic energy radiated requires a relatively short pulse rise time but a relatively large pressurized area. One or more stabilizers at the top of this section would dampen the propagation of the tube wave above this region.

In a rigid bottom hole assembly, most of the upstream pulse energy propagates up the inside of the drill collars and is wasted. A shock sub can decouple the tool from the drill collar to absorb some of the upstream pressure pulse. The upstream pressure pulse generated by the tool can cause the shock sub to extend, thus partially attenuating some of the upstream pulse energy. This extension can also attenuate some of the tube wave energy. Decoupling the bottom hole assembly can also generate a larger mechanical impulse on the borehole bottom.

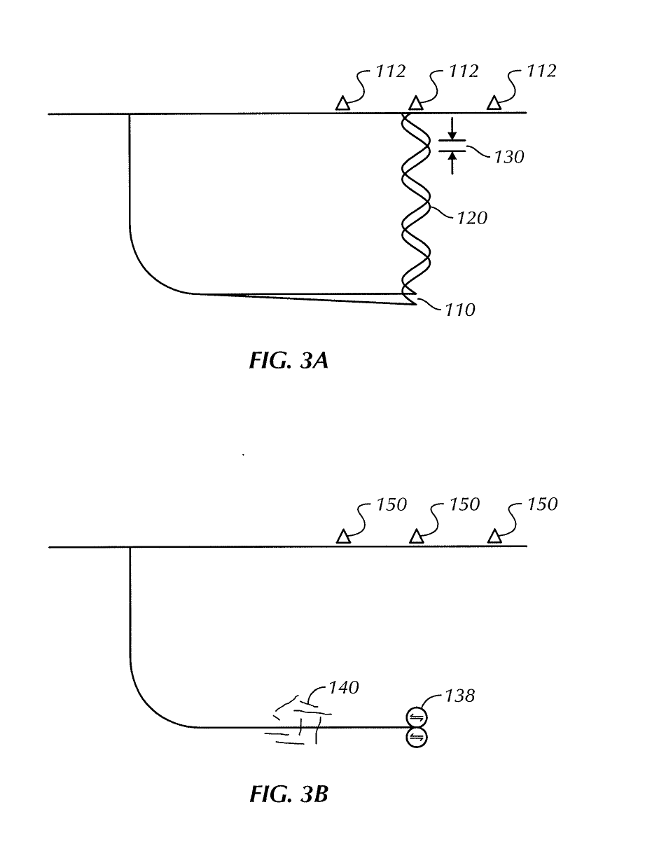

FIG. 3A shows the pulse generation source 110 used to track the depth of the bottom hole assembly while drilling in relation to the geophones 112 located at the surface. Impulses 120 from the source 110 are received by the geophones 112 located on surface above the planned well trajectory. The arrival time of the pulses are monitored continuously. If the well deviates from the planned trajectory the phase of the signal received by the geophones will shift, the phase shift represented by the timing difference 130 between the two pulse maximums. Changes in signal phase can be tracked accurately using phase-lock-loop algorithms. Multiple geophones on the surface would allow accurate tracking of the location of the bit and therefore the well trajectory.

Locating natural fractures is an important objective for planning multistage hydraulic fracture treatments. The seismic source generates both a pressure impulse due to pressure changes in the annulus and a shear wave due to the impact of the bit on the hole bottom. The shear energy radiates in a toroidal pattern around the bit 138 as shown in FIG. 3B. These shear waves will be highly attenuated by the presence of natural fracture network 140 while compression waves will be less affected. The shear wave and compression wave amplitude can be monitored using 3D seismic sensors 150 on surface. The location of natural fracture networks can therefore be determined by monitoring the shear wave energy as a function of measured depth of the well.

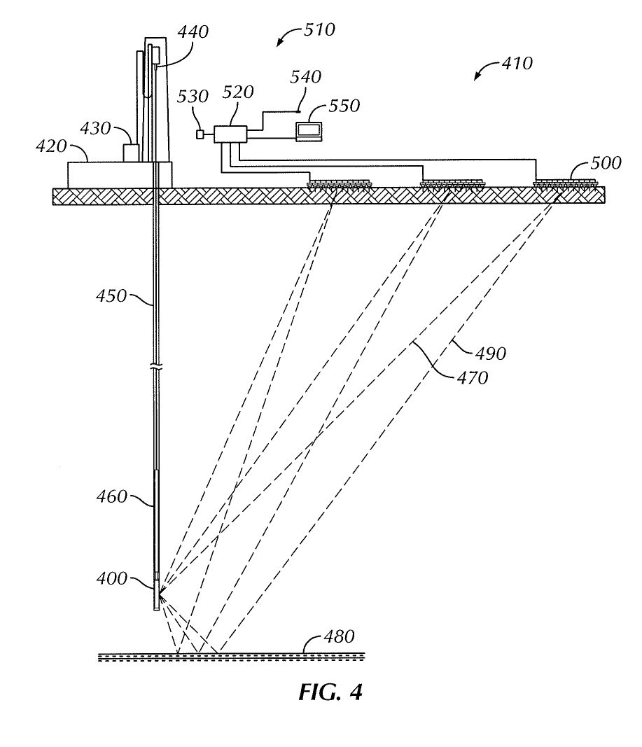

FIG. 4 illustrates an embodiment of a low frequency seismic while drilling system 400 having surface data acquisition equipment 410. A surface drilling rig 420 having a mud pump 430 with a controlled mud flow system including pilot signal sensors having a radio transmitter 440 connects downhole to drill pipe 450. A drill pipe section 450 connects to a drill collar section 460 that then connects to the low frequency seismic while drilling assembly 400. When in operation, the pulse generation section of the low frequency seismic while drilling assembly 400 generates low frequency pulse waves some of which directly propagate to the surface, on a path as represented by dashed lines 470. In addition, geological seismic reflection features 480 can naturally occur downhole that additionally direct reflected waves towards the surface, on a path as represented by dashed lines 490. The waves that propagate to the surface are received by geophone arrays 500 that send data to a data acquisition unit 510. The data acquisition unit 510 includes a data correlator 520, a radio receiver 530 that receives information from the pilot signal sensors and radio transmitter 440 of the drilling rig 420. The data acquisition unit 510 further can have a data acquisition trigger 540 to initiate data acquisition and a data recording system 550. In an embodiment, the data acquisition unit 510 data recording system 550 can further include a real-time or delayed data processing system to analyze the collected seismic data. The data analysis can further be displayed to on-site operations personnel or remote personnel through a remote communications system (not shown).

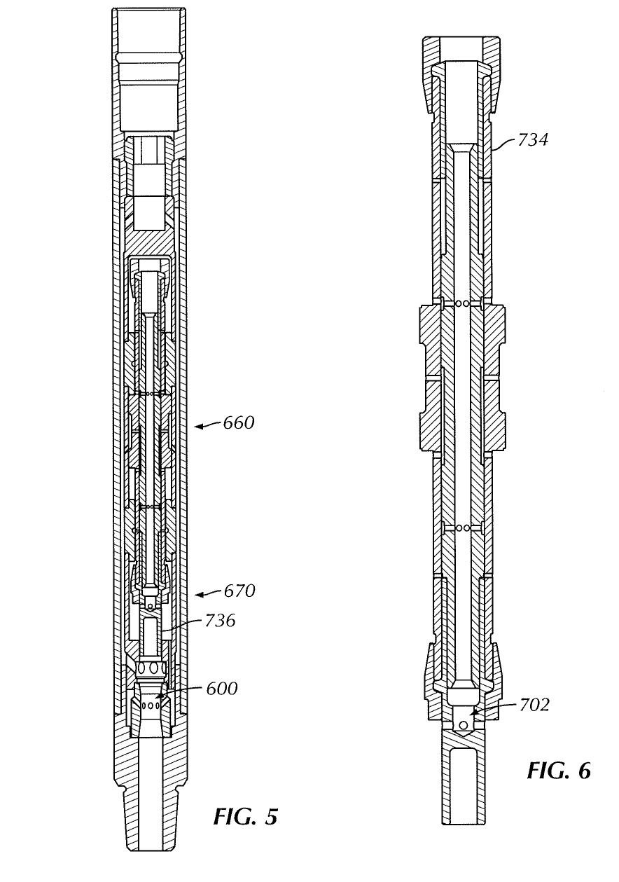

FIG. 5 illustrates details of the valve cartridge that allow the cycle rate of the tool to be reduced independently of the pulse width by increasing the diameter of the poppet seat flow passages 600, and/or by decreasing the diameter and number of poppet seat flow passages 600.

In another alternate embodiment, as illustrated by FIG. 6, the cycle rate may be reduced by increasing the stroke of the piston assemblies 734 and pilot 736 as shown. Increasing the stroke length also increases the pulse width and cost of the tool. In addition, in this embodiment or separately, the impulse width can be controlled by enlarging or restricting other flow passages that are not shown in FIG. 5 or 6 but are described in detail in U.S. patent application Ser. No. 12/957,049.

Although the concepts disclosed herein have been described in connection with the preferred form of practicing them and modifications thereto, those of ordinary skill in the art will understand that many other modifications can be made thereto. Accordingly, it is not intended that the scope of these concepts in any way be limited by the above description.

1. A seismic-while-drilling system including a bottom hole assembly, the bottom hole assembly comprising:
a drill bit section;
a pulse generation section connected to the drill bit section, the pulse generation section comprising:
an external housing having a valve cartridge assembly configured to create periodic seismic pulses,
the external housing and the valve cartridge assembly of the pulse generation section configured to generate periodic seismic pulses below 2 Hz.

2. The seismic-while-drilling system of claim 1, wherein the pulse generation section has a plurality of flow restrictions to generate seismic pulses below 2 Hz.

3. The seismic-while-drilling system of claim 2, wherein the flow restrictions and corresponding duration of each said seismic pulse is matched to the travel time of said pulse along the length of said housing.

4. The seismic while drilling system of claim 2, wherein the rise time of each said seismic pulse is shorter than 10 milliseconds.

5. The seismic-while-drilling system of claim 1, wherein the bottom hole assembly further comprises an acoustic baffle section comprising an acoustic baffling element to reflect and attenuate pulse energy generated by the pulse generation section.

6. The seismic-while-drilling system of claim 1, wherein the pulse generation section further comprises a motor section to drive the drill bit section.

7. The seismic-while-drilling system of claim 5, wherein the acoustic baffling section further comprises at least one stabilizer having stabilizer vanes extending substantially to the borehole sidewalls, the stabilizer serving as an acoustic baffle to reflect and attenuate pulse energy generated by the pulse generation section.

8. The seismic-while-drilling system of claim 5, wherein the acoustic baffling section further comprises a plurality of stabilizers to reflect and attenuate pulse energy generated by the pulse generation section.

9. The seismic-while-drilling system of claim 5, wherein the acoustic baffling section further comprises a plurality of baffle sections to reflect and attenuate pulse energy generated by the pulse generation section.

10. A seismic-while-drilling system including a bottom hole assembly, the bottom hole assembly comprising:
a drill bit section;
a pulse generation section connected to the drill bit section, the pulse generation section comprising:
an external housing having a shock sub decoupler configured to couple with a valve cartridge assembly,
the external housing, shock sub decoupler and valve cartridge assembly configured to generate seismic pulses below 2 Hz; and
an acoustic baffle section connected to the pulse generation section, the acoustic baffle section comprising:
an acoustic baffling element to reflect and attenuate pulse energy generated by the pulse generation section.

11. The seismic-while-drilling system of claim 10 wherein the duration of each said seismic pulse is matched to the travel time of said pulse along the length of said housing.

12. The seismic-while-drilling system of claim 10, wherein the pulse generation section has a plurality of flow restriction passages configured in combination with the pulse generation section external housing dimensions to generate seismic pulses below 2 Hz.

13. The seismic-while-drilling system of claim 10, wherein the acoustic baffling section further comprises at least one stabilizer having stabilizer vanes extending substantially to the borehole sidewalls, the stabilizer serving as an acoustic baffle to reflect and attenuate pulse energy generated by the pulse generation section.

14. The seismic-while-drilling system of claim 10, wherein the acoustic baffling section further comprises a plurality of stabilizers to reflect and attenuate pulse energy generated by the pulse generation section.

15. The seismic-while-drilling system of claim 10, wherein the acoustic baffling section further comprises a plurality of baffle sections to reflect and attenuate pulse energy generated by the pulse generation section.

16. A method of generating sub 2 Hz seismic pulses while drilling, the method comprising the steps of:
running a bottom hole assembly into a borehole, the bottom hole assembly comprising a drill bit section, a pulse generation section, and an acoustic baffling section, the pulse generation section having a valve cartridge assembly section configured with a plurality of flow restrictions, the diameters of the flow restrictions and the length and diameter of the external housing configured to generate seismic pulses below 2 Hz;
drilling with the drill bit section of the bottom hole assembly;
generating sub 2 Hz seismic pulses with the pulse generation section; and
reflecting pulse energy with the acoustic baffling section.

17. The method of generating sub 2 Hz seismic pulses while drilling described in claim 16, the method further comprising the step of:
providing a pulse generation section that comprises an external housing greater than 5 meters in length and a valve cartridge assembly section of the pulse generation section having a stroke length greater than 2 meters.

18. The method of generating sub 2 Hz seismic pulses while drilling described in claim 16, the method further comprising the step of:
reflecting pulse energy with the acoustic baffling section wherein the acoustic baffling section comprises a stabilizer with stabilizer vanes extending substantially to the borehole sidewalls, the stabilizer serving to reflect and attenuate pulse energy generated by the pulse generation section.

19. The method of generating sub 2 Hz seismic pulses while drilling described in claim 16, the method further comprising the step of:
locating the bit by continuously monitoring the timing of sub 2 Hz seismic pulses received by an array of multiple sensors located on the surface.

20. The method of generating sub 2 Hz seismic pulses while drilling described in claim 16, the method further comprising the step of:
decoupling pulse energy from the pulse generation section from the drillstring with a shock sub decoupler configured in the pulse generation section external housing.
